(19) United States
(12) Patent Application Publication
(10) Pub. No.: US 2024/0124000 A1
(43) Pub. Date: Apr. 18, 2024

(54) DETECTION AND COMPENSATION OF WHEEL SPEED SENSOR FAILURE

(71) Applicant: Robert Bosch GmbH, Stuttgart (DE)

(72) Inventors: Anthony J. Farrell, Brooklyn, MI (US); Erica Hingst, Plymouth, MI (US); Ankit Shah, Canton, MI (US); Sivaraja Velusamy, Northville, MI (US)

(21) Appl. No.: 18/047,585

(22) Filed: Oct. 18, 2022

(51) Int. Cl. B60W 50/02; B60W 50/14

(52) U.S. Cl. CPC B60W 50/0205; B60W 50/14; B60W 2050/0215; B60W 2422/70; B60W 2510/081

(57) ABSTRACT

Systems and methods for detecting a failure of a wheel speed sensor. One example system includes an encoder and an electronic processor. The electronic processor is configured to receive, from the wheel speed sensor, a wheel speed, receive, from the encoder, a signal, and determine, based on the signal from the encoder, a positional change of an electric motor shaft of the electric motor. The electronic processor is configured to determine, based on the wheel speed and the positional change of the electric motor, whether the wheel speed sensor is faulty.

### BACKGROUND OF THE INVENTION

Vehicle systems utilize a number of sensors for operation. For example, a wheel speed sensor may be utilized to measure the speed of a respective wheel of the vehicle.

### SUMMARY

Inaccurate readings from a wheel speed sensor, or complete failure of the sensor itself, may impair or compromise operations of one or more vehicle systems. There is thus a need to detect failure of such sensors as soon as possible. It may also be desirable to employ a system to mitigate or compensate for the failure of one or more wheel speed sensors so that the respective impacted vehicle system(s) may continue operation. Accordingly, systems and methods described herein provide, among other things, mechanisms and techniques for detecting a failure of a wheel speed sensor and deriving a wheel speed via a motor encoder.

One aspect provides a system for detecting a failure of a wheel speed sensor of a vehicle. The system includes an encoder and an electronic processor. The electronic processor is configured to receive, from the wheel speed sensor, a wheel speed, receive, from the encoder, a signal, and determine, based on the signal from the encoder, a positional change of an electric motor shaft of the electric motor. The electronic processor determines, based on the wheel speed and the positional change of the electric motor, whether the wheel speed sensor is faulty.

Another aspect provides a method for detecting a failure of a wheel speed sensor of a vehicle. The method includes receiving, with an electronic processor from the wheel speed sensor, a wheel speed and receiving, with the electronic processor from an encoder, a signal. The method further includes determining, with the electronic processor based on the signal from the encoder, a positional change of an electric motor shaft of the electric motor and determining, with the electronic processor based on the wheel speed and the positional change of the electric motor, whether the wheel speed sensor is faulty.

Yet another aspect provides a vehicle. The vehicle includes an encoder and an electronic processor. The electronic processor is configured to receive, from the wheel speed sensor, a wheel speed, receive, from the encoder, a signal, and determine, based on the signal from the encoder, a positional change of an electric motor shaft of the electric motor. The electronic processor determines, based on the wheel speed and the positional change of the electric motor, whether the wheel speed sensor is faulty.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate aspects, features, examples, and embodiments of concepts that include the claimed subject matter, and explain various principles and advantages of those aspects, features, examples, and embodiments.

FIG. 1 is a block diagram of a vehicle system, in accordance with some aspects.

FIG. 2 schematically illustrates a wheel speed and motor speed sensor system of the system of FIG. 1, in accordance with some aspects.

FIG. 3 schematically illustrates an electronic controller of the system of FIG. 1, in accordance with some aspects.

FIG. 4 is a flowchart of a method performed by the system of FIG. 1 for detecting a failure of a wheel speed sensor of the system of FIG. 2, in accordance with some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects, features, examples, and embodiments.

The apparatus and method components have been represented where appropriate by conventional symbols in the drawings, showing only those specific details that are pertinent to understanding the aspects, features, examples, and embodiments presented so as not to obscure the disclosure with details that will be readily apparent to those of ordinary skill in the art having the benefit of the description herein.

### DETAILED DESCRIPTION

As noted, several vehicle systems (for example, an electronic stability program (ESP), a traction control system (TCS), an adaptive cruise control (ACC) system, etc.) utilize wheel speed sensors during operation. A defective wheel speed sensor thus may negatively impact the performance of such systems. There is therefore a need to not only detect failure of such sensors, but also a need for a means to mitigate or compensate for the failure of sensors so that the respective impacted vehicle system(s) may continue operation.

Accordingly, systems and methods described herein provide, among other things, mechanisms and techniques for detecting a failure of a wheel speed sensor and deriving a wheel speed via a motor encoder. As described herein, a “failure” of the wheel speed sensor (also referred to as a “faulty” wheel speed sensor) is a case where the measurement(s) from the wheel speed sensor are inaccurate or absent. For example, the wheel speed sensor may not be properly calibrated or unable to detect a wheel speed at all.

Before aspects of the invention are explained in detail, it is to be understood that the invention is not limited in its application to the details of construction and the arrangement of components set forth in the following description or illustrated in the following drawings. The invention is capable of being practiced or of being carried out in various ways.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

It should also be noted that a plurality of hardware and software-based devices, as well as a plurality of different structural components may be utilized to implement the invention. It should also be noted that a plurality of hardware and software-based devices, as well as a plurality of different structural components may be used to implement the invention. In addition, it should be understood that aspects of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the invention may be implemented in software (for example, stored on non-transitory computer-readable medium) executable by one or more processors. As such, it should be noted that a plurality of hardware and software-based devices, as well as a plurality of different structural components may be utilized to implement the invention. For example, “control units” and “controllers” described in the specification can include one or more electronic processors, one or more physical memory modules including non-transitory computer-readable medium, one or more input/output interfaces, and various connections (for example, a system bus) connecting the components.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

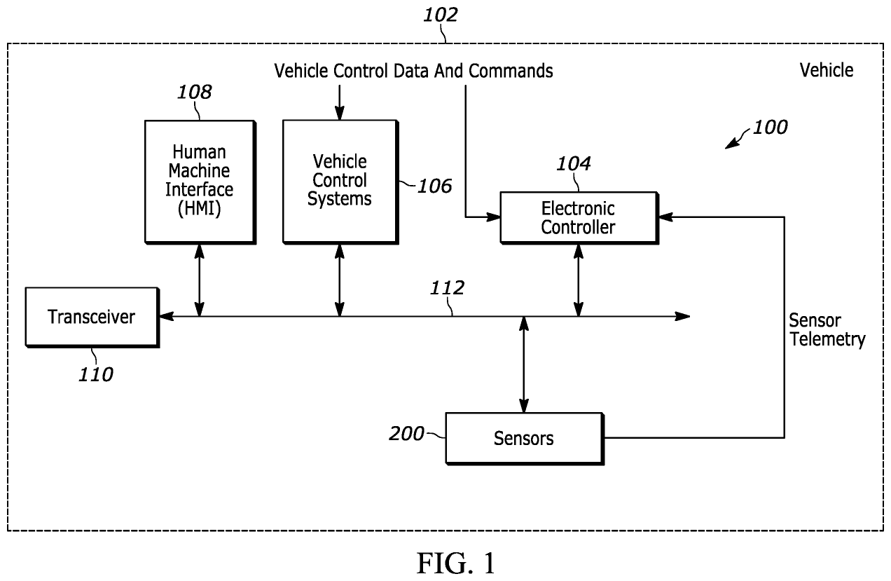

FIG. 1 is a block diagram of a vehicle system 100 according to some aspects. The vehicle system 100 may be mounted on, or integrated into, a vehicle 102. It should be noted that, although in the description that follows, the term “vehicle,” although described and illustrated herein as a four-wheeled motor vehicle (for example, an automotive, a truck, etc.), the systems and methods described herein may be applied to various types and configurations of vehicles including any number of wheels (for example, a motorcycle). The vehicle 102 may be capable of operating partially or fully autonomously, being controlled manually by a driver, or some combination of both.

In the example illustrated, the vehicle system 100 includes an electronic controller 104, vehicle control systems 106, a human machine interface (HMI) 108, and sensors 200. In some aspects, the vehicle system 100 also includes a transceiver 110. The components of the vehicle system 100, along with other various modules and components are electrically coupled to each other by or through one or more control or data buses (for example, the bus 112), which enable communication therebetween. The use of control and data buses for the interconnection between, and communication among, the various modules and components would be known to a person skilled in the art in view of the invention described herein. In some aspects, the bus 112 is a Controller Area Network (CAN™) bus. In some aspects, the bus 112 is an automotive Ethernet™, a FlexRay™ communications bus, or another suitable wired bus. In alternative aspects, some or all of the components of the vehicle system 100 may be communicatively coupled using suitable wireless modalities (for example, Bluetooth™ or near field communication). For ease of description, the vehicle system 100 illustrated in FIG. 1 includes one of some of the foregoing components. Alternative aspects may include one or more of a component or may exclude or combine some components. For example, in some aspects, the vehicle system 100 may include multiple electronic controllers, multiple HMIs, multiple transceivers, multiple busses, or a combination thereof.

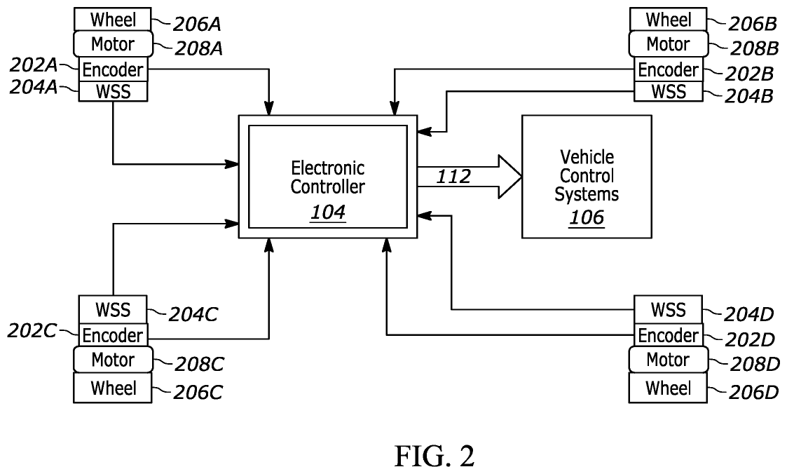

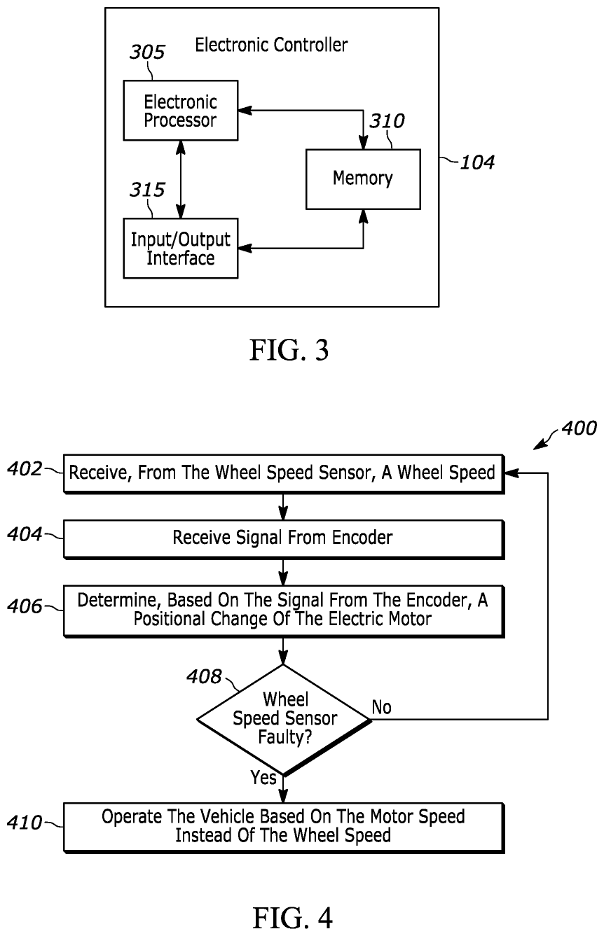

The electronic controller 104 (described more particularly below with respect to FIGS. 2 and 3) operates the vehicle control systems 106 and the sensors 200 to control the vehicle 102 as described herein. The electronic controller 104 receives sensor telemetry from the sensors 200 and determines control data and commands for the vehicle 102. The electronic controller 104 transmits the vehicle control data to, among other things, the vehicle control systems 106 to operate one or more components of the vehicle 102 (for example, by generating braking signals, acceleration signals, steering signals, or the like).

The vehicle control systems 106 include controllers, sensors, actuators, and the like for controlling aspects of the operation of the vehicle 102 (for example, steering, acceleration, braking, shifting gears, and the like). The vehicle control systems 106 are configured to send and receive data relating to the operation of the vehicle 102 to and from the electronic controller 104.

The sensors 200 determine one or more attributes of the vehicle 102 (and, in some aspects, an environment surrounding the vehicle 102) and communicate information regarding those attributes to the other components of the vehicle system 100 using, for example, electrical signals. The vehicle attributes include, for example, the position of the vehicle or portions or components of the vehicle, the movement of the vehicle or portions or components of the vehicle, the forces acting on the vehicle or portions or components of the vehicle, vehicle speed, longitudinal acceleration, and lateral acceleration, and the like. The sensors 200 may include, for example, vehicle control sensors (for example, sensors that detect accelerator pedal position, brake pedal position, and steering wheel position [steering angle]).

As illustrated in FIG. 2, the sensors 200 include one or more encoders 202A-202D and one or more wheel speed sensors 204A-204D. The encoders 202A-202D are rotary encoders configured to measure a rotational position of a respective electric motor 208A-208D that each drives a respective wheel (or wheels) 206A-206D of the vehicle 102. For example, in some aspects, each encoder 202A-202D is configured to measure positional information regarding the electric motor 208A-208D (in particular a shaft thereof, which is not shown) driving the wheel 206A-206D. It should be understood that while a single encoder 202A-202D is illustrated as being configured to measure a position of a motor 208A-208D for a single, respective wheel 206A-206D, in some aspects, a single encoder 202A-202D may measure a position of a single motor 208A-208D driving more than one wheel 206A-206D.

The wheel speed sensors 204A-204D are each configured to measure a speed of a respective wheel 206A-206D of the vehicle 102. The electronic controller 104 is configured to receive measurements from the respective encoders 202A-202D and wheel speed sensors 204A-204D and control an operation of the vehicle 102 (via one or more command signals to one or more of the vehicle control systems 106). The electronic controller 104, as explained in more detail below, receives and interpret the signals received from the sensors 200 (in particular, the encoders 202A-202D and the wheel speed sensor(s) 204A-204D) to detect a failure of one or more of the wheel speed sensors 204A-204D.

Returning to FIG. 1, the HMI 108 provides visual output, such as, for example, graphical indicators (i.e., fixed or animated icons), lights, colors, text, images, combinations of the foregoing, and the like. The HMI 108, for example, includes a suitable display mechanism for displaying the visual output, such as, for example, an instrument cluster, a mirror, a heads-up display, a center console display screen (for example, a liquid crystal display (LCD) touch screen, or an organic light-emitting diode (OLED) touch screen), or other suitable mechanisms. In alterative aspects, the display screen may not be a touch screen. In some aspects, the HMI 108 displays a graphical user interface (GUI) (for example, generated by the electronic controller and presented on a display screen) that enables a driver or passenger to interact with the vehicle 102. The HMI 108 may also provide audio output to the driver such as a chime, buzzer, voice output, or other suitable sound through a speaker included in the HMI 108 or separate from the HMI 108. In some aspects, the HMI 108 provides haptic outputs to the driver by vibrating one or more vehicle components (e.g., the vehicle's steering wheel and the seats), for example, using a vibration motor. In some aspects, HMI 108 provides a combination of visual, audio, and haptic outputs.

As mentioned above, in some aspects, the vehicle 102 includes a transceiver 110. The electronic controller 104 utilizes the transceiver 110 for communicating data over one or more wireless communications networks (e.g., cellular networks, satellite networks, land mobile radio networks, etc.). Such communications networks include wireless connections, wired connections, or combinations of both. In some aspects, the electronic controller 104 is configured to transmit and receive information regarding a failure of a wheel speed sensor (for example, one or more of the wheel speed sensors 204A-204D) to and from a remote database server (not shown). The transceiver 110 may also provide wireless communications within the vehicle 102 using suitable network modalities (e.g., Bluetooth™, near field communication (NFC), Wi-Fi™, and the like). Accordingly, the transceiver 110, in some aspects, communicatively couples the electronic controller 104 and other components of the vehicle system 100 with networks or electronic devices inside the vehicle 102, outside the vehicle 102 (for example, a portable electronic communications device and/or a remote database server), or a combination thereof. The transceiver 110 may includes other components that enable wireless communication (e.g., amplifiers, antennas, baseband processors, and the like), which for brevity are not described herein and which may be implemented in hardware, software, or a combination of both. Some aspects include multiple transceivers or separate transmitting and receiving components (e.g., a transmitter and a receiver) instead of a combined transceiver 110.

FIG. 3 is a block diagram illustrating the electronic controller 104 according to some aspects. As illustrated in FIG. 3, the electronic controller 104 includes an electronic processor 305 (for example, a microprocessor, application specific integrated circuit, etc.), a memory 310, and an input/output interface 315. The memory 310 may be made up of one or more non-transitory computer-readable media and includes at least a program storage area and a data storage area. The program storage area and the data storage area can include combinations of different types of memory, such as read-only memory (“ROM”), random access memory (“RAM”) (for example, dynamic RAM (“DRAM”), synchronous DRAM (“SDRAM”), etc.), electrically erasable programmable read-only memory (“EEPROM”), flash memory, or other suitable memory devices. The electronic processor 305 is coupled to the memory 310 and the input/output interface 315. The electronic processor 305 sends and receives information (for example, from the memory 310 and/or the input/output interface 315) and processes the information by executing one or more software instructions or modules, capable of being stored in the memory 310, or another non-transitory computer readable medium. The software can include firmware, one or more applications, program data, filters, rules, one or more program modules, and other executable instructions. The electronic processor 305 is configured to retrieve from the memory 310 and execute, among other things, software for vehicle control, and for performing methods as described herein.

The input/output interface 315 transmits and receives information from devices external to the electronic controller 104 (for example, over one or more wired connections, wireless connections, or a combination thereof), such as, for example, components of the vehicle system 100 via the bus 112. The input/output interface 315 receives input (e.g., from the sensors 200, the HMI 108, etc.), provides system output (e.g., to the HMI 108, etc.), or a combination of both. The input/output interface 315 may also include other input and output mechanisms, which for brevity are not described herein and which may be implemented in hardware, software, or a combination of both.

It should be understood that although FIG. 3 illustrates only a single electronic processor 305, memory 310, and input/output interface 315, alternative examples of the electronic controller 104 may include multiple processors, multiple memory modules, multiple input/output interfaces, or a combination thereof. It should also be noted that the vehicle system 100 may include other electronic controllers, each including similar components as, and configured similarly to, the electronic controller 104. In some aspects, the electronic controller 104 is implemented partially or entirely on a semiconductor (for example, a field-programmable gate array [“FPGA”] semiconductor) chip. Similarly, the various modules and controllers described herein may be implemented as individual controllers, as illustrated, or as components of a single controller. In some aspects, a combination of approaches may be used.

As noted, failure of a wheel speed sensor (for example, one or more of the wheel speed sensors 204A-204D) may negatively impact performance of one or more vehicle control systems 106 of the vehicle 102. Accordingly, FIG. 4 illustrates an example method 400 for detecting (and compensating for) a failure of a wheel speed sensor. Although the method 400 is described in conjunction with the vehicle system 100 as described herein, the method 400, as mentioned above, could be used with other systems and vehicles. In addition, the method 400 may be modified or performed differently than the specific example provided. As an example, the method 400 is described as being performed by the electronic controller 104 and, in particular, the electronic processor 305. However, it should be understood that in some examples, portions of the method 400 may be performed by other devices or subsystems of the vehicle system 100. For ease of description, the method 400 is described herein in terms of a single wheel speed sensor 204A and encoder 202A corresponding to a respective wheel 206A driven by a respective electric motor 208A of the vehicle 102. It should be understood that the method 400 may be utilized in the failure detection of other wheel speed sensors 204B-204D based on readings from one or more of a respective encoder 202B-202D.

At block 402, the electronic processor 305 receives a wheel speed from the wheel speed sensor 204A. The wheel speed corresponds to a speed of the respective wheel 206A. At block 404, the electronic processor 305 receives a signal from the encoder 202A, and, at block 406, the electronic processor 305 determines a positional change of the electric motor 208A (in particular, an electric motor shaft thereof) based on the signal.

At block 408, the electronic processor 305 determines, based on the wheel speed and the positional change of the electric motor 208A, whether the wheel speed sensor 204A is faulty. In particular, the electronic processor 305 is configured to derive, from the positional change, a motor speed of the electric motor 208A. The motor speed of the electric motor 208A is approximately the same as or at least corresponds to the speed of the wheel 206A that the motor 208A drives. Thus, the electronic processor 305 may determine a failure of the wheel speed sensor 204A based on a comparison of the wheel speed to the derived motor speed (for example, if the wheel speed differs from the motor speed by a predetermined threshold).

In response to determining that the wheel speed sensor 204A is not faulty, the electronic processor 305 returns to block 402 of the method 400. In response to determining that the wheel speed sensor 204A is faulty, the electronic processor operates the vehicle 102 based on the motor speed instead of the wheel speed (at block 410). In particular, the electronic processor 305 uses the motor speed for operation of one or more vehicle control systems 106 of the vehicle 102. Such vehicle control systems 106 include, for example, an electronic stability program (ESP), a traction control system (TCS), an antilock braking system (ABS), an electronic brakeforce distribution (EBD) system, an autonomous emergency braking system (AEB), or a combination thereof. The vehicle control systems 106 may also include one or more of an adaptive cruise control (ACC) system, a brake disc cleaning system, an automatic warning brake system, a hill hold control system, a drag torque control system, and a trailer sway control system. In addition to adjusting an operation of the vehicle 102 in response to the detection that the wheel speed sensor 204A is faulty, the electronic processor 305, in some aspects, generates an alert in response to determining that the wheel speed sensor 204A is faulty. The alert may be a haptic, visual, audible alert (or some combination thereof). The alert may be generated, for example, to a user of the vehicle 102 via the HMI 108. In some aspects, the electronic processor 305 may, alternatively or in addition to provide the alert to a user of the vehicle 102 via the HMI 108, provide the alert to a remote database server (for example, a remote database server of a manufacturer or provider of the vehicle 102).

Thus, the subject matter described herein provides, among other things, systems and methods for detecting (and compensating for) a faulty wheel speed sensor of a vehicle.

In the foregoing specification, specific aspects, features, examples, and embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

Various features, advantages, and aspects, features, examples, and embodiments are set forth in the following claims.

What is claimed is:

1. A system for detecting a failure of a wheel speed sensor of a vehicle, the system comprising:
an encoder; and
an electronic processor configured to:
receive, from the wheel speed sensor, a wheel speed,
receive, from the encoder, a signal,
determine, based on the signal from the encoder, a positional change of an electric motor shaft of the electric motor, and
determine, based on the wheel speed and the positional change of the electric motor, whether the wheel speed sensor is faulty.

2. The system of claim 1, wherein the electronic processor is further configured to
derive, from the positional change of the electric motor, a motor speed, and
determine that the wheel speed sensor is faulty when the motor speed differs from the wheel speed by a predetermined threshold.

3. The system of claim 2, wherein the electronic processor is further configured to operate the vehicle based on the motor speed instead of the wheel speed in response to determining that the wheel speed sensor is faulty.

4. The system of claim 3, wherein the electronic processor is configured to operate the vehicle based on the motor speed by adjusting an operation of at least one selected from the group consisting of an electronic stability program (ESP), a traction control system (TCS), an antilock braking system (ABS), an electronic brakeforce distribution (EBD) system, and an autonomous emergency braking system (AEB).

5. The system of claim 3, wherein the electronic processor is configured to operate the vehicle based on the motor speed by adjusting an operation of at least one selected from the group consisting of an adaptive cruise control (ACC) system, a brake disc cleaning system, an automatic warning brake system, a hill hold control system, a drag torque control system, and a trailer sway control system.

6. The system of claim 1, wherein the electronic processor is further configured to generate an alert in response to determining that the wheel speed sensor is faulty.

7. A method for detecting a failure of a wheel speed sensor of a vehicle, the method comprising:
receiving, with an electronic processor from the wheel speed sensor, a wheel speed;
receiving, with the electronic processor from an encoder, a signal;
determining, with the electronic processor based on the signal from the encoder, a positional change of an electric motor shaft of the electric motor; and
determining, with the electronic processor based on the wheel speed and the positional change of the electric motor, whether the wheel speed sensor is faulty.

8. The method of claim 7, the method further comprising
deriving, from the positional change of the electric motor, a motor speed, and
determining that the wheel speed sensor is faulty when the motor speed differs from the wheel speed by a predetermined threshold.

9. The method of claim 8, the method further comprising operating the vehicle based on the motor speed instead of the wheel speed in response to determining that the wheel speed sensor is faulty.

10. The method of claim 9, wherein operating the vehicle based on the motor speed includes adjusting an operation of at least one selected from the group consisting of an electronic stability program (ESP), a traction control system (TCS), an antilock braking system (ABS), an electronic brakeforce distribution (EBD) system, and an autonomous emergency braking system (AEB).

11. The method of claim 9, wherein operating the vehicle includes adjusting an operation of at least one selected from the group consisting of an adaptive cruise control (ACC) system, a brake disc cleaning system, an automatic warning brake system, a hill hold control system, a drag torque control system, and a trailer sway control system.

12. The method of claim 7, the method further comprising generating an alert in response to determining that the wheel speed sensor is faulty.

13. A vehicle comprising:
an encoder; and
an electronic processor configured to:
receive, from the wheel speed sensor, a wheel speed,
receive, from the encoder, a signal,
determine, based on the signal from the encoder, a positional change of an electric motor shaft of the electric motor, and
determine, based on the wheel speed and the positional change of the electric motor, whether the wheel speed sensor is faulty.

14. The vehicle of claim 13, wherein the electronic processor is further configured to
derive, from the positional change of the electric motor, a motor speed, and
determine that the wheel speed sensor is faulty when the motor speed differs from the wheel speed by a predetermined threshold.

15. The vehicle of claim 14, wherein the electronic processor is further configured to operate the vehicle based on the motor speed instead of the wheel speed in response to determining that the wheel speed sensor is faulty.

16. The vehicle of claim 15, wherein the electronic processor is configured to operate the vehicle based on the motor speed by adjusting an operation of at least one selected from the group consisting of an electronic stability program (ESP), a traction control system (TCS), an antilock braking system (ABS), an electronic brakeforce distribution (EBD) system, and an autonomous emergency braking system (AEB).

17. The vehicle of claim 13, wherein the electronic processor is further configured to generate an alert in response to determining that the wheel speed sensor is faulty.
